(19) United States
(12) Patent Application Publication
(10) Pub. No.: US 2010/0291980 A1
(43) Pub. Date: Nov. 18, 2010

(54) CORN COB CONVEYOR SYSTEM WITH POSITIVE DE-HUSKING CAPABILITY

(76) Inventor: Jonathan E. Ricketts, Ephrata, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/550,224

(22) Filed: Aug. 28, 2009

Related U.S. Application Data
(60) Provisional application No. 61/216,521, filed on May 18, 2009.

(51) Int. Cl. B02B 3/00; B08B 5/00

(52) U.S. Cl. 460/26; 460/100

(57) ABSTRACT

A conveyor system for receiving corn cobs with husks still attached thereto after harvesting of the corn from the cobs, and detaching the husks from the cobs, including a conveyor inclined at an angle of at least about 30 degrees and bounding a passage for receiving a flow of the cobs including the husks attached thereto, the conveyor including apparatus configured and operable for mechanically grasping and detaching the husks from the cobs and pulling the detached husks through the conveyor, and at least one blower configured and operable for urging the husks within the passage toward the apparatus. The conveyor system can be provided in connection with a cob collection device, such as on a trailer to be towed by a harvester. The conveyor system can also include an additional conveyor or conveyors, optionally including apparatus for removing or cleaning crop residue from the cobs.

This application claims the benefit of U.S. Provisional Application No. 61/216,521, filed May 18, 2009.

### TECHNICAL FIELD

This invention relates generally to a conveyor system for corn cobs from which the corn has been harvested, which system more particularly incorporates a capability for positively removing attached husks from the cobs, and other crop residue.

### BACKGROUND OF THE INVENTION

U.S. Provisional Application No. 61/216,521, filed May 18, 2009, is incorporated herein in its entirety by reference.

Presently, there is an increased demand for corn cobs as a feedstock for cellulosic ethanol, as well as other uses. As a result, there is heightened interest in collecting corn cobs during corn harvest. There is also concern by some that cob collection may reduce soil nutrient content. In this regard, crop residue or stover, e.g., corn stalks, leaves, husks and cobs, are traditionally left on the field after harvest, and break down over time to replenish soil nutrients. If a component of the stover, e.g., cobs is instead collected, nutrient levels could be lowered as a result. To mitigate this concern, some consider it desirable when collecting cobs, to collect only the cobs, that is, clean cobs with substantially all residual husks, leaves and stalks removed, and return the other stover to the field. Thus, it is sought to provide a cob conveyor adapted for operation in connection or association with a corn harvester, which incorporates an ability to separate or clean the cobs from the other stover, including removing husks and the like attached to the cobs, and return the other stover to the field or another location. It is also desirable for the cleaned cobs to be as compact as possible, e.g., without attached husks and the like, so as to maximize the amount of cobs that can be collected in a given collection space or containers for receiving the cobs. Still further, for some techniques for producing ethanol from corn cobs, the presence of other stover, e.g., husks and the like, is undesired, and for a load of cobs of a given volume, the amount of compensation paid will be reduced if significant other stover is present.

Numerous apparatus have been proposed for use in connection with cob conveyor devices and systems, for cleaning or separating cobs from the other stover. To illustrate, prior to the early 1960's, the common corn harvesting practice involved picking the ears of corn in the field, removing husks from the ears, and transporting the ears still containing the corn kernels to a corn crib, and later shelling the corn off of the cobs at a stationary sheller. This harvesting procedure has been almost entirely replaced by modern self-propelled combine type harvesters, which separate and collect the corn kernels, and discharge the cobs and other stover onto the field.

Combines which harvest the corn and separate the kernels from the cobs and other stover or residue, then discharge the cobs and other stover onto the field, are now the industry standard. More recently, devices for collecting cobs discharged from combines have been developed. Several of such known devices have variously utilized a towed cart or wagon for receiving and holding the cobs, and a conveyor system for conveying the cobs from the combine to the cart or wagon. Some of the known cob conveyor devices and systems also include apparatus for separating the cobs from the other stover or residue, mainly using air flow. Reference in this regard, Flamme U.S. Pat. No. 5,941,768, issued Aug. 24, 1999, which discloses a cob collection unit pulled behind a combine to collect on a first conveyor all the residue discharged from the combine, with a separation unit behind the conveyor including a second conveyor, and utilizing a fan to suck the stover from the cobs as they are released from the top of the second conveyor and to blow the stover back onto the field. Redekop et al. U.S. Patent Publication Nos. 20090095662 published Apr. 16, 2009; 20090104952 published Apr. 23, 2009; and 20090124309 published May 14, 2009, disclose a pulled cob collection unit, which utilizes a sequential series of inclined belt conveyors, and blower or suction fans for directing air through the discharged material as it falls from the upper end of one conveyor onto a lower end of the next conveyor, such that the heavier cobs are to continue to the next conveyor and the lighter stover or residue will be carried away by the air flow, with the cobs being conveyed into a collection tank by a further conveyor or conveyors.

Reference also Stukenholtz U.S. Pat. No. 6,358,141 issued Mar. 19, 2002, and Redekop et al. U.S. Patent Publication No. 20090137295, which disclose cob collection systems on a combine which utilize on-board bins and cob separation using sieves on the combine itself.

A shortcomings variously of the known cob collection devices and systems, is a lack of a capability for reliably removing husks and/or leaves, or fragments thereof, which still remain attached to the cobs after processing of the cobs through the systems of the combine, including gathering of the corn plants and separation of the corn ears from the stalks by the header, conveying through the feeder, agitation and separation of the kernels from the cobs by the threshing mechanism, and post-threshing handling, including in some cases passage through sieves and other systems designed for separating the cobs from the other residue or stover. Such attached husks and the like are disadvantageous as they increase the volume of the collected cobs, and reduce the ease of conveyance and compactability thereof, such that for a given volume of collected cobs, an undesirable portion of the volume can comprise the husks and the like which can have a lower energy content compared to the cobs alone, and create open spaces or interstices between the collected cobs, which factors can combine to reduce the value of a given volume of the collected cobs, as noted above.

Thus, what is sought is a cob conveyor device or system, preferably adapted for operation in association with a harvester, which provides one or more of the capabilities, namely, separating cobs from other crop residue or stover, including positively separating or detaching attached husks from the cobs, and which overcomes one or more of the disadvantages, set forth above.

### SUMMARY OF THE INVENTION

What is disclosed is a cob conveyor device or system preferably adapted for operation in association with a harvester, which provides one or more of the capabilities, namely, separating cobs from other crop residue or stover, including positively separating or detaching attached husks from the cobs, and which overcomes one or more of the disadvantages, set forth above.

According to a preferred aspect of the invention, the conveyor system includes an inclined apparatus or conveyor bounding a passage or space for receiving a flow of the cobs including the husks attached thereto. The inclined apparatus or conveyor is configured and operable for mechanically grasping and detaching the husks from the cobs and pulling the detached husks through the conveyor. The system also preferably includes at least one blower configured and operable for urging the husks within the passage toward the apparatus. The conveyor system can be provided in connection with a cob collection device, such as on a trailer to be towed by a harvester. The conveyor system can also include an additional conveyor or conveyors, optionally operable in cooperation with the blower or blowers for removing or cleaning crop residue from the cobs, and one or more of which additional conveyors can be configured and operable for conveying the cleaned and de-husked cobs to the optional collection device.

According to a preferred embodiment of the invention, the inclined apparatus or conveyor is disposed below the passage bounded thereby, and has an upwardly facing surface oriented at an angle of inclination of at least about 30 degrees relative to horizontal, extending through a first end and an opposite second end lower than the first end. The surface preferably consists of an array of husking rolls extending between the ends, essentially forming a husking bed, configured and positioned for receiving the flow of the cobs including the husks attached thereto, and positively removing the husks therefrom. The husking rolls can also be configured for conveying the cobs along the surface, preferably in cooperation with gravity. Each of the husking rolls bounds a gap smaller than the cobs extending through the conveyor and thus connecting with a region on the opposite side of the rolls, which will be below the inclined apparatus or conveyor in the preferred configuration wherein the inclined apparatus or conveyor bounds a lower region of the passage.

Each of the husking rolls is supported for rotation about an axis therethrough, and is connected to drive apparatus configured for drivingly rotating the husking rolls about the axes, respectively. The husking rolls preferably include husking elements thereon configured such that when the husking rolls are rotated by the drive, the elements will grasp and detach the husks from the cobs and drive or propel the detached husks through the gaps into the region below the inclined conveyor, away from the cobs. Some or all of the elements on the husking rolls can also be configured to be operable for propelling or conveying the cobs along the inclined conveyor during the rotation, preferably in cooperation with gravity.

According to another preferred aspect of the invention, the blower is configured and operable for directing the flow of air in a suitable direction for bringing the husks into contact with the husking rolls, which can be, but is not limited to, a generally downward direction, a generally upward direction, a sideward direction, or a combination of these directions, as desired or required for a particular application. In this regard, it has been found that the direction of the air flow can be generally parallel or even at a small acute angle, to the surface of the inclined apparatus or conveyor, to provide good material throughput, and the cobs can tumble, bounce, roll and otherwise move in a variety of orientations in a generally agitated manner through the passage bounded by the inclined apparatus, while still being effectively de-husked. This is enabled by using the blower or blowers to generate a sufficiently higher air pressure condition in the passage through which the cobs flow, e.g., above the husking rolls for the preferred embodiment, compared to the pressure in the region on the opposite side (below in the preferred embodiment) of the rolls, such that a portion of the air flow will automatically divert and flow through the gaps toward the lower pressure region, and carry the husks into the gaps.

In the above regard, it has been observed that because the corn kernels have already been removed or harvested from the cobs, e.g., as a result of passage through and processing by at least the threshing system of a combine, any remaining husks or husk fragments will be attached at only one end, to the butt end of the cob, with the remaining portion of the husk loose, so as to be capable of extending in a wide variety of directions from the butt of the cob. These husks or husk fragments have a thin, flat, tough paper-like consistency that has been found to provide suitable aerodynamic drag characteristics such that, with sufficient air flow toward the gaps adjacent the husking rolls, the husks will be caught and/or carried by the diverted air flow toward and into the gaps, sufficiently so as to be engaged or grasped by the rolls and inducted into the gaps in the desired manner, regardless of the initial orientation of the cobs. Still further, because the cobs (and most cob fragments) are relatively hard, and larger than the gaps, they will not pass through the gaps, such that the husks will be separated from the cobs in the desired manner, by the continued rotational movement and resultant pulling action of the associated husking roll. Other smaller elements of the crop material will also be inducted into and pass through the gaps, and be thus separated or cleaned from the cobs.

According to another preferred aspect of the invention, at least one conveyor is provided disposed and configured for conveying the flow of the cobs in an airborne, random or agitated, rapidly moving stream into the flow of air through the passage bounded by the inclined husk removing apparatus or conveyor, such that the flow of air will carry the cobs into proximity with the inclined conveyor and facilitate the induction of the husks into the gaps bounded by the husking rolls so as to be detached thereby. This conveyor can be further configured for directly receiving the cobs from an accompanying harvesting machine such as a combine, or from another accompanying conveyor or other suitable source. The conveyor can be disposed at least partially above the inclined conveyor, in spaced relation thereto, so as to bound and define the upper region of the passage for the flow of the cobs in proximity to, above and along, the inclined de-husking apparatus or conveyor.

As a further preferred aspect of the invention, at least one additional conveyor is provided, configured and operable for receiving the cobs from the inclined de-husking apparatus or conveyor, and conveying the cobs into a cob collection device. Still further, the inclined apparatus, and additional conveyors can be provided on a self contained platform or vehicle, such as, but not limited to, a trailer, configured for operation in cooperation with a harvesting machine, in particular, for receiving a flow of corn cobs and other crop material therefrom.

### BRIEF DESCRIPTION OF THE DRAWINGS

FIG. 1 is a fragmentary side view of a representative agricultural harvesting machine, including a cob conveyor system with a de-husking capability according to the invention;

FIG. 1a is another fragmentary side view of the cob conveyor system with de-husking capability which is an extension of FIG. 1;

FIG. 2 is a fragmentary schematic side view of the cob conveyor system;

FIG. 3 is a sectional view taken along line 3-3 of FIG. 2;

FIG. 4 is an enlarged view of husk removing apparatus of the system of the invention, showing a drive thereof;

FIG. 5 is an illustration of the husk removing apparatus in operation;

FIG. 5a is a top view of the husk removing apparatus, showing representative husking elements of husking rolls thereof;

FIG. 6 is another illustration of the husk removing apparatus in operation;

FIG. 7 is still another illustration of the husk removing apparatus in operation;

FIG. 8 is a simplified schematic side view of the system of the invention, showing a blower of the system in a first alternative location;

FIG. 9 is a simplified top view of the husk removing apparatus, showing husking rolls in an alternative upwardly and downwardly extending orientation;

FIG. 10 is another simplified schematic side view of the system of the invention, showing a blower of the system in a second alternative location; and

FIG. 11 is still another simplified schematic side view of the system of the invention, showing a blower of the system in a third alternative location.

### DETAILED DESCRIPTION OF THE INVENTION

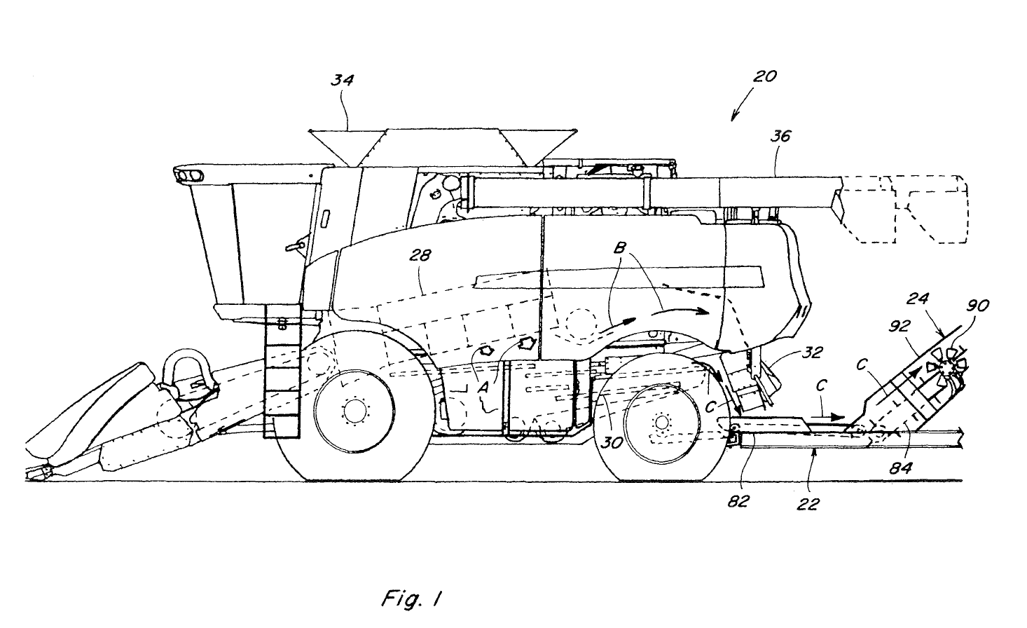

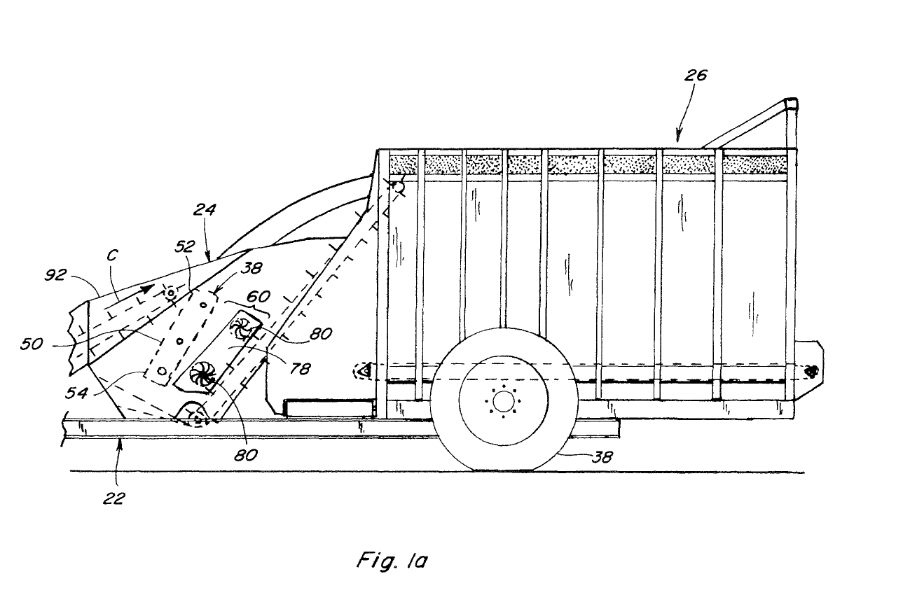

Referring now the drawings, in FIGS. 1 and 1a, a representative agricultural harvesting machine 20 is shown, connected in towing relation to a trailer 22 carrying a cob conveyor system having a positive de-husking capability 24 and a cob collection device 26. Machine 20 illustrated is a combine constructed and operable in the well known manner for harvesting whole ears of corn from corn plants as the machine travels over a field. Machine 20 then conveys the ears of corn into a threshing system 28 which removes most of the husk surrounding the ears, and the corn kernels from cobs of the ears, and directs the corn, cobs, or fragments thereof, and other residue or stover, to a cleaning system 30, as denoted by arrows A in FIG. 1. At the same time, larger residue such as leaves and the like, are directed (arrows B) to a spreader 32 operable for distributing the larger residue over the field.

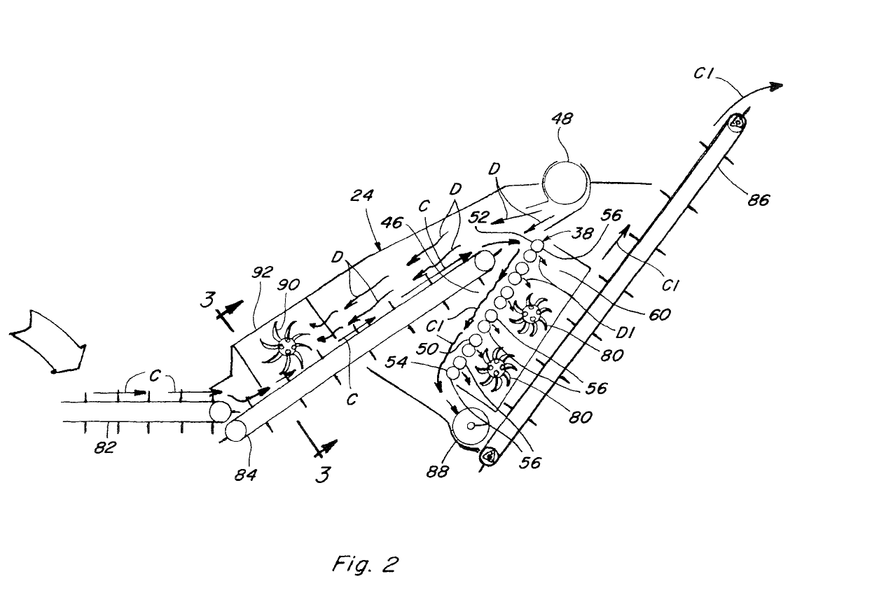

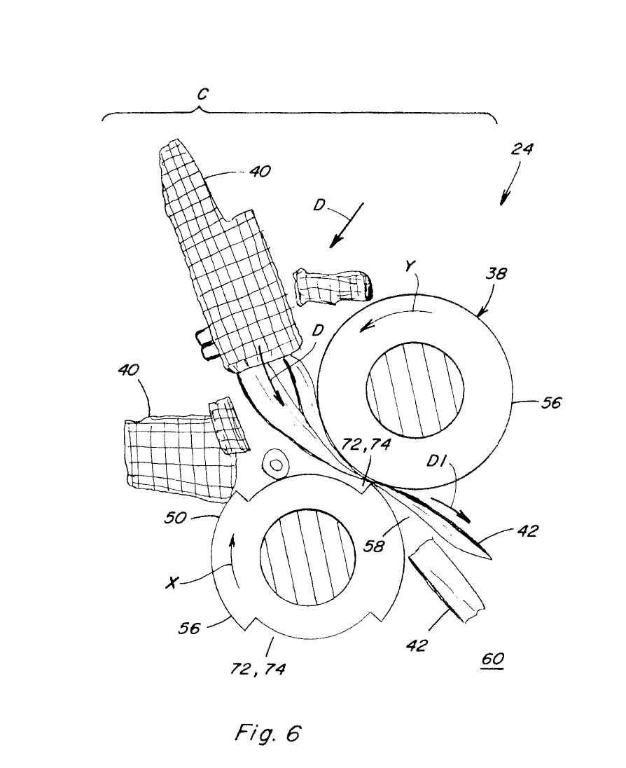

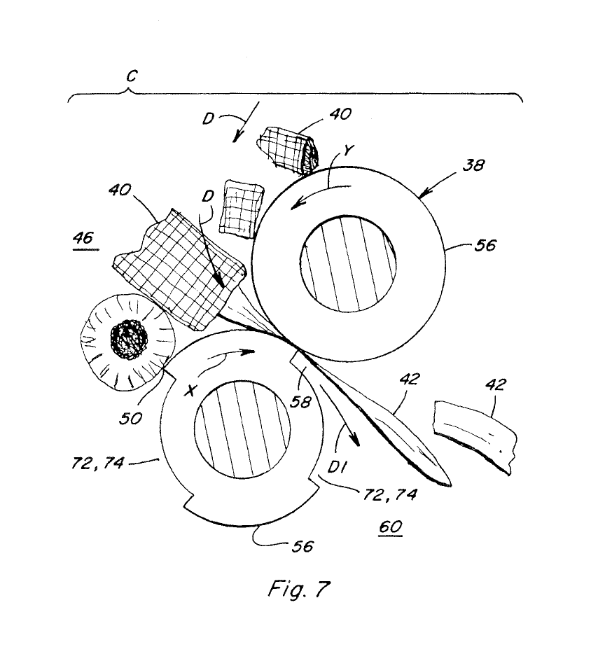

Cleaning system 30 is operable for separating the kernels of corn from the cobs and other residue or stover, and directing the clean corn into an onboard clean grain tank 34 or other receiver, and directing a flow of cobs and other residue or stover rearwardly from machine 20, as denoted by arrows C. The clean corn is then unloaded from tank 34 using an unloader conveyor 36 in the conventional manner, by swinging conveyor 36 to a sidewardly extending position (not shown—conveyor 36 being illustrated in a stowed or travel position here). Referring also to FIGS. 2, 3, 4, 5, 5a, 6 and 7, cob conveyor system 24 includes an inclined conveyor or apparatus 38 constructed and operable according to the teachings of the present invention, for receiving the flow of cobs C, which includes individual cobs and cob fragments (collectively referred to by numeral 40) including husks 42 attached thereto and other elements of corn residue or stover 44 (FIG. 2), and removing remaining husks 42 attached to cobs 40, that is, de-husking the cobs. The cleaned or de-husked cobs 40 are then conveyed in a flow, denoted by arrows C1, to cob collection device 26.

Inclined apparatus 38 is preferably disposed so as to bound a passage 46, adapted for receiving flow C. Preferably, inclined apparatus 38 is located below, and bounds a lower region of passage 46, such that flow C will pass over apparatus 38, although other locations can alternatively or additionally be used, such as the sides of passage 46. Inclined apparatus 38 is preferably oriented at an angle of at least about 30 degrees relative to horizontal, which is sufficient such that cobs and stover and other residue can flow downwardly therealong under the power of gravity alone, without building up thereon, and apparatus 38 can also incorporate a conveying capability to positively convey flow C therealong, if required or desired. Here, inclined apparatus 38 is illustrated oriented at about a 55 to 60 degree angle to horizontal, which is more preferred. Flow C is preferably introduced into the upper end of passage 46, and inclined apparatus 38 is configured and operable for de-husking cobs 40 which pass thereover or therealong, by mechanically grasping and pulling or detaching husks 42 therefrom and carrying detached husks 42 through apparatus 38, so as to be effectively separated or cleaned from flow C, which, as a result is denoted as flow C1, and will be directed or conveyed to cob collection device 26, as will be explained.

System 24 also preferably includes at least one fan or blower 48 configured and operable for facilitating flow C along inclined apparatus 38 to improve throughput, and also the directing of husks 42 into contact with apparatus 38 for de-husking thereby. In FIG. 2, blower 48 is illustrated located above inclined apparatus 38 in position for directing a flow of air, denoted by arrows D, downwardly at an incline which about matches or differs by only a small acute angle to the incline of apparatus 38, but can alternatively be located elsewhere, as will be explained, and can be supplemented by one or more additional fans or blowers. Blower 48 can be suitably powered, by a fluid or electric motor, belt drive, or the like.

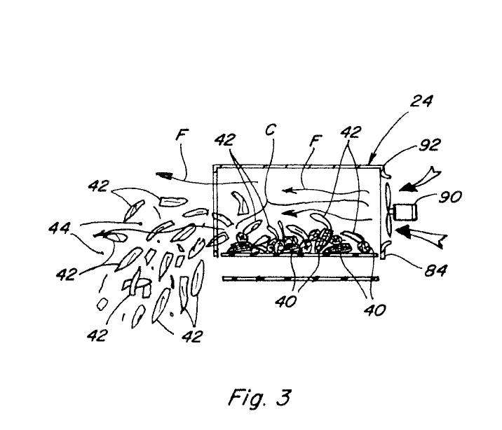

Inclined apparatus 38 has an upwardly facing surface 50 oriented at the angle of inclination of at least about 30 degrees relative to horizontal, which here is between 55 and 60 degrees, extending through a first end 52 of apparatus 38 and an opposite second end 54 lower than first end 52, as best shown in FIGS. 2 and 3. Surface 50 preferably consists of an array of husking rolls 56 extending between ends 52 and 54, configured and positioned for receiving flow C thereover. Husking rolls 56 can also be configured for facilitating conveyance or passage of flow C along surface 50, preferably in cooperation with gravity, by virtue of the inclined orientation.

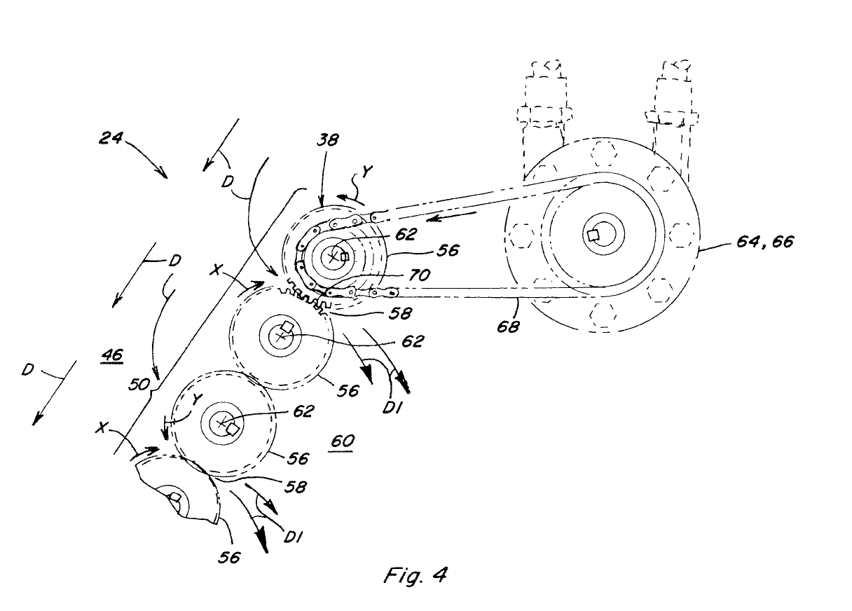

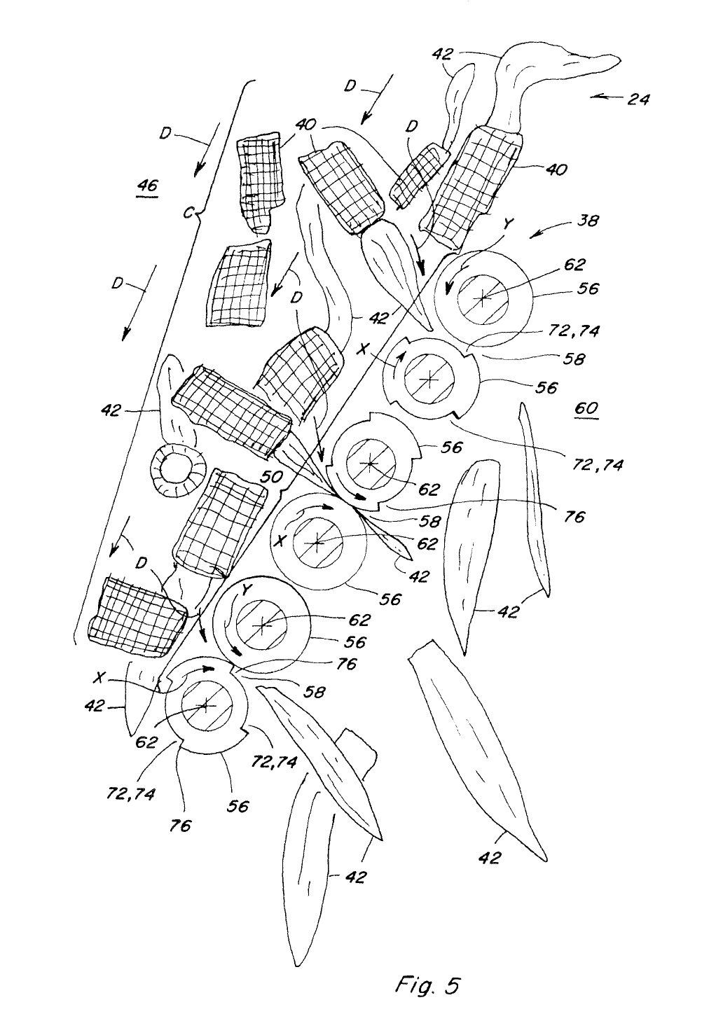

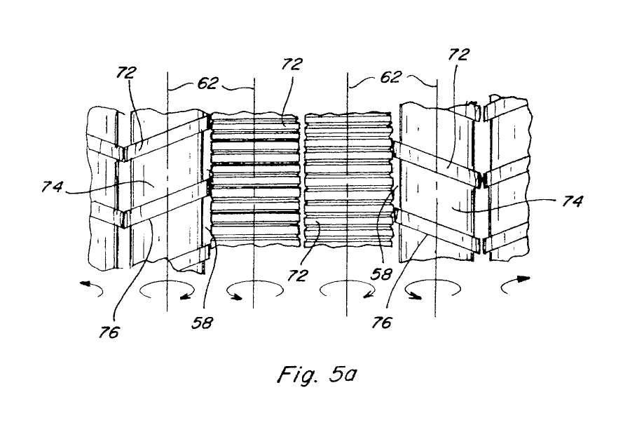

Each husking roll 56 is preferably an elongate, cylindrical member which bounds a gap 58 on one side which is smaller than cobs 40 and most cob fragments, which gaps 58 extend through inclined apparatus 38 and connect with a region 60 on the opposite side of rolls 56, which here, is below the inclined apparatus 38. Each husking roll 56 is supported for rotation about an axis 62 therethrough as shown in FIGS. 4 and 5, and is connected to a drive 64 (FIG. 4) configured for drivingly rotating rolls 56 about the axes, respectively. Drive 64 can include, for instance, a fluid motor 66, electric motor, or the like, connected in driving relation to a drive train including a chain 68 driving a series of gears 70, or alternatively, shafts, belts, chains, or the like, operable for counter-rotating selected adjacent ones of the rolls, as denoted by arrows X and Y.

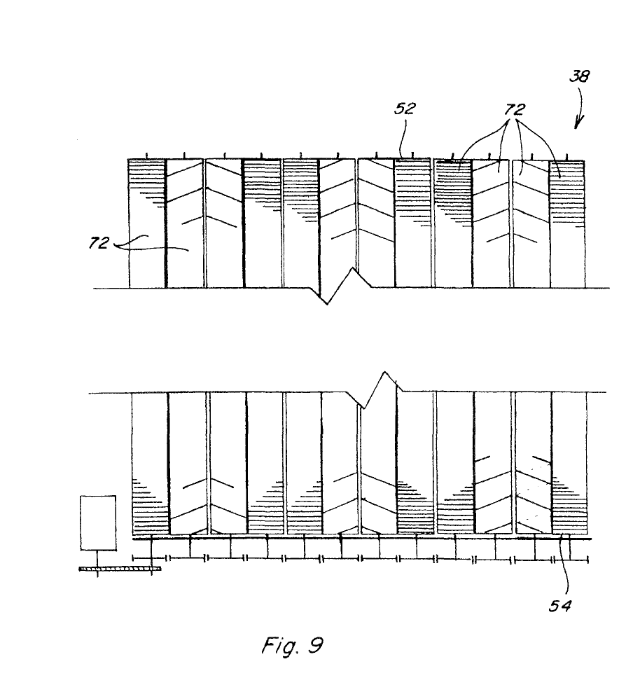

Husking rolls 56 preferably include husking elements 72 on the outer surfaces thereof, configured such that when husking rolls 56 are rotated, elements 72 will mechanically grasp and detach husks 42 from cobs 40 and drive or propel the detached husks through gaps 58 into region 60 below rolls 56, away from the cobs, as best illustrated in FIGS. 5, 5a, 6 and 7. Some or all of elements 72 can also be configured to be operable for propelling or conveying the cobs along inclined apparatus 38 during the rotation, preferably in cooperation with gravity, as noted above. It is contemplated that husking elements 72 can have a variety of configurations, e.g., shapes and features, for grasping and pulling husks 42 from cobs 40, husking elements 72 on some of rolls 56 preferably being configured as longitudinally extending helical concave regions 74 on the outer surfaces of rolls 56, bounded by longitudinally extending, raised helical edges 76, while others of the elements 72 on opposing ones of rolls 56 are preferably configured as annular serrations extending about the rolls, the opposing husking elements being adapted to cooperatively operate for grasping husks 42 and rapidly pulling them from cobs 40, and downwardly into and through gaps 58, along with any loose stover 44, as the rolls are rotated. The rotation and husking elements 72 can also cooperate so as to act to convey cobs 40 rapidly along surface 50 toward the lower end thereof, for throughput purposes. Here, husking rolls 56 are illustrated as extending sidewardly across apparatus 38 at the bottom region of passage 46, but they can alternatively be oriented to extend upwardly and downwardly therealong at the incline of apparatus 38, or otherwise oriented as desired or required for a particular application, as illustrated in FIG. 9.

Here also, it should be understood that unlike conventional husking bed applications wherein husks are removed from ears of corn prior to removal of the corn kernels from the cobs, and wherein the ears are conveyed in orderly end to end relation along the husking rolls, here, the corn kernels have already been removed from the cobs and the cobs with remaining attached husks can comprise whole cobs, and/or cob fragments of various sizes, and, individually, will be substantially lighter in weight compared to whole ears of corn. Additionally, as a result of prior processing by machine 20, husks 42 which remain attached to cobs 40 will be oriented in a variety of ways relative to the cobs, including extending sidewardly, backwards, etc., and the husks will likely be tough and/or resilient, stringy, and otherwise hard to detach. Flow of cobs C can also contain a large number of cobs 40 which are at least initially airborne within the upper region of passage 46, some of which cobs will tumble or bounce on surface 50 of apparatus 38, and flow C will also contain a wide variety of other loose residue or stover 44, such that it should be apparent that flow C will not comprise an orderly end-to-end procession of ears. As a result, husking rolls 56 and associated husking elements 72 are desirably configured to grasp and detach husks 42 from cobs 40, while in a state of agitation, e.g., airborne, rapidly tumbling and rolling along and above surface 50 in a variety of orientations, essentially as illustrated in FIGS. 5, 6 and 7.

As noted above, blower 48 is configured and operable for directing flow of air D generally along inclined apparatus 38. Additionally, air flow D is sufficient, and passage 46 and inclined apparatus 38 are configured, such that a higher air pressure condition will be generated in passage 46 above husking rolls 56, compared to the pressure in region 60 below rolls 56, such that a portion of air flow D will automatically divert and flow through gaps 58 toward region 60, as denoted by arrows D1. As noted above, any remaining husks 42 or husk fragments will be attached at only one end, to the butt end of cobs 40, with the remaining portion of the husk loose, so as to be capable of extending in a wide variety of directions from the butt of the cob. These husks 42 or husk fragments have a thin, flat, paper-like consistency that has been found to provide suitable aerodynamic drag characteristics such that they can be caught and/or carried by the diverted air flow D1 toward and into gaps 58, so as to be engaged or grasped by husking elements 72, and inducted into the gaps. Cobs 40 to which husks 42 are attached will be pulled by the husks toward gaps 58 also, but, because cobs 40 are relatively hard, and larger than gaps 72, they will not pass through the gaps, such that husks 42 will be detached from cobs 40 by the continued rotational movement of the associated husking rolls through the gaps. Other smaller elements of stover 44 will also be inducted into and pass through gaps 58 into region 60, to be separated or cleaned from cobs 40. For the above purposes, blower 48 can include a centrifugal type fan as illustrated, or alternatively, one or more radial fans, as desired or required for providing the necessary air flow C.

Region 60 below rolls 56 can be expected to receive a relatively large quantity of detached husks 42 and other stover, and thus should be configured for either storing or discharging this material. In the present embodiment of system 38 the latter approach is chosen, Here, apparatus 38 preferably being bounded by at least one sidewardly facing opening 78, as best shown in FIG. 1a, and includes at least one sidewardly directed blower 80, suitably driven by a motor, such as a fluid or electric motor, a belt drive, or the like, operable for blowing the detached husks 42 and other stover sidewardly, outwardly and away from apparatus 38. In this regard, ducting about region 60 can be provided and configured for facilitating outflow of husks, and also induction through gaps 58, as desired or required. As another alternative, region 60 can be open, or just downwardly open, such that the husks can just fall to the ground, or can include diverter guides for directing the falling material to the side.

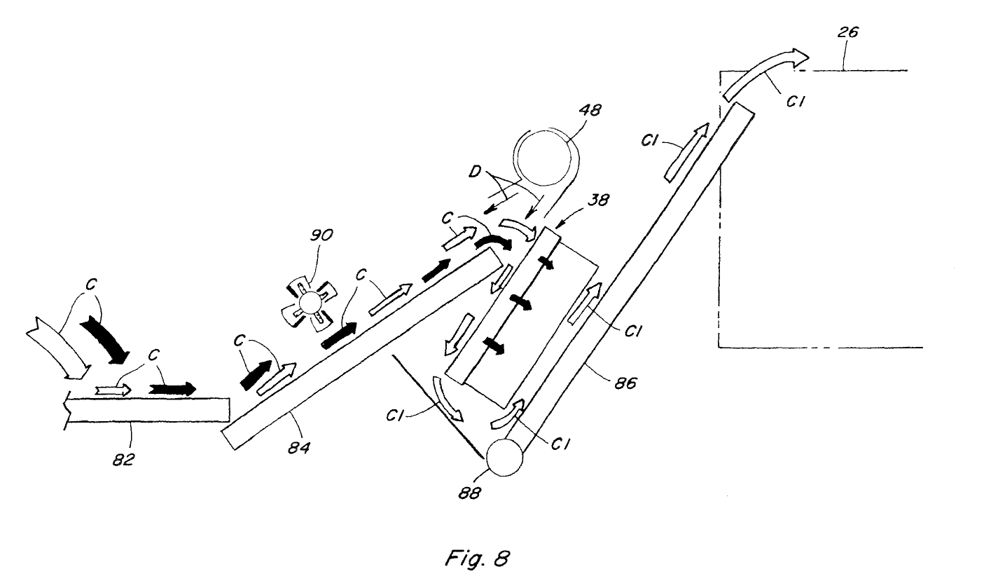

As discussed above, cob conveyor system 24 including apparatus 38 is illustrated disposed on a trailer 22 in connection with a harvesting machine 20, which is a combine, for receiving flow C of cobs 40. A wide variety of manners of delivery can be utilized for conveying flow C to apparatus 38, including one or more mechanical conveyors, and/or airborne delivery, as desired or required for a particular application. Here, referring also to FIG. 8, which is a schematic representation of one preferred embodiment of system 24, a first generally horizontal conveyor 82 is supported on trailer 22 in a position for receiving flow C therefrom, including cobs (denoted by white arrows), and husks (black arrows), and is configured and operable for conveying flow C to a second conveyor 84, also supported on trailer 22. Second conveyor 84 is inclined upwardly and rearwardly from first conveyor 82, and is disposed for directing flow C into passage 46 over inclined apparatus 38, so as to be de-husked in the above-described manner. System 24 includes a third conveyor 86 configured and operable for receiving and conveying de-husked flow C1 of cleaned or de-husked cobs upwardly and rearwardly, and discharging flow C1 into cob collection device 26. Additionally, a cross or gathering conveyor 88, which can be, for instance, a helical auger type, can be provided for collecting the cobs of flow C1 and directing them onto the lower end of third conveyor 86, as desired or required to facilitate throughput. Conveyors 82, 84 and 86 can be suitably configured for performing the above-described functions, e.g., slatted, and along with conveyor 88, can be driven, for instance, in the well known conventional manner, using a fluid or electric motor, a chain or a belt drive. As another alternative, second conveyor 84 and/or third conveyor 86 can comprise one or more helical auger type conveyors, if desired. Additionally, it can be observed that second conveyor 84 forms the upper bounds of passage 46 and thus forms a containment for flow C, for facilitating air flows D1 through gaps 58.

As an additional feature of system 24, at least one blower 90 can be provided in association with conveyor 84, and operable for directing a sideward flow of air, denoted by arrows F in FIG. 2, across flow C for removing loose elements of stover 44 therefrom. Additionally, a portion of flow D from blower 48 can be directed downwardly along second conveyor 84, which flow can intersect and be diverted sidewardly by flow F from blower 90, so as to carry any husks and stover 44 picked up and carried by that portion of flow D sidewardly away from conveyor 84. In this regard, conveyor 84 can include a duct 92 thereover for containing cob flow C, air flow F, and any portion of air flow D directed along conveyor 84, including suitable sidewardly directed air inlet and outlets for accommodating flow F. Additionally, a similar blower arrangement can be provided in association with third conveyor 86, if desired or required.

Cob collection device 26 is preferably a substantially conventional constructed grain enclosure typically found on grain carts and wagons. Device 26 generally includes an upstanding wall structure 94 bounding an interior cavity or chamber 96 adapted for receiving and holding a quantity of cobs 40. Collection device 26 can also optionally include a cover (not shown). Third conveyor 86 of conveyor system 24 is configured in cooperation with collection device 26, for conveying cob flow C1 upwardly through or over a front wall of device 26, into interior chamber 96. Third conveyor 86 can be adjustable in speed and/or angle of inclination, for varying the cob distribution within chamber 96, and in the latter regard, the front wall of device 26 can include a suitable opening for cooperatively receiving conveyor 86 in one or more positions. Device 26 can also include a conveyor bottom 100 in chamber 96, operable for distributing cobs to some extent therein, and also for unloading, in the well known manner. Here, it should be understood that system 24 of the invention can include a wide variety of alternative apparatus for conveying or feeding crop residue including cobs to inclined apparatus 38 for de-husking thereby, as well as for conveying the de-husked cobs to a collection device.

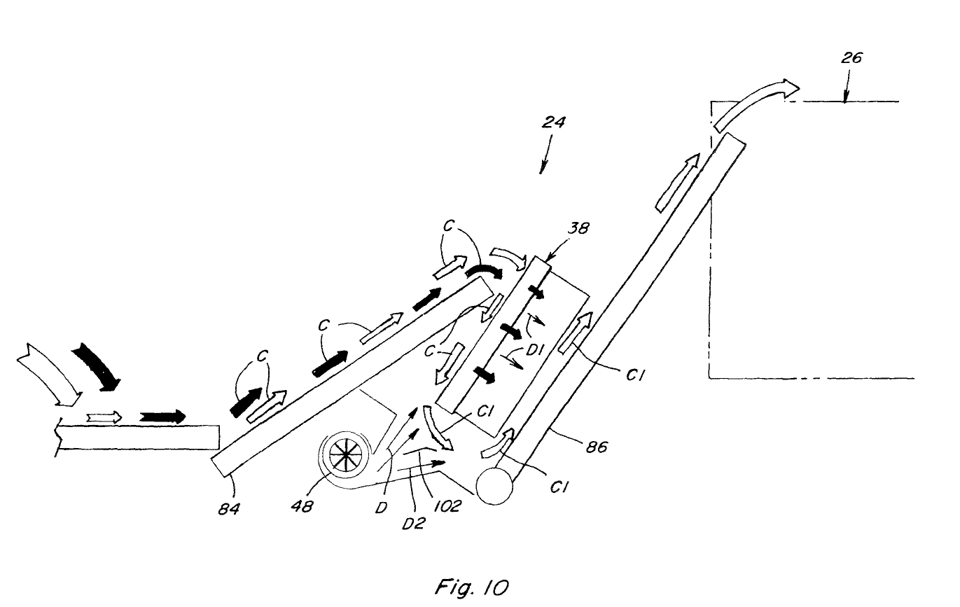

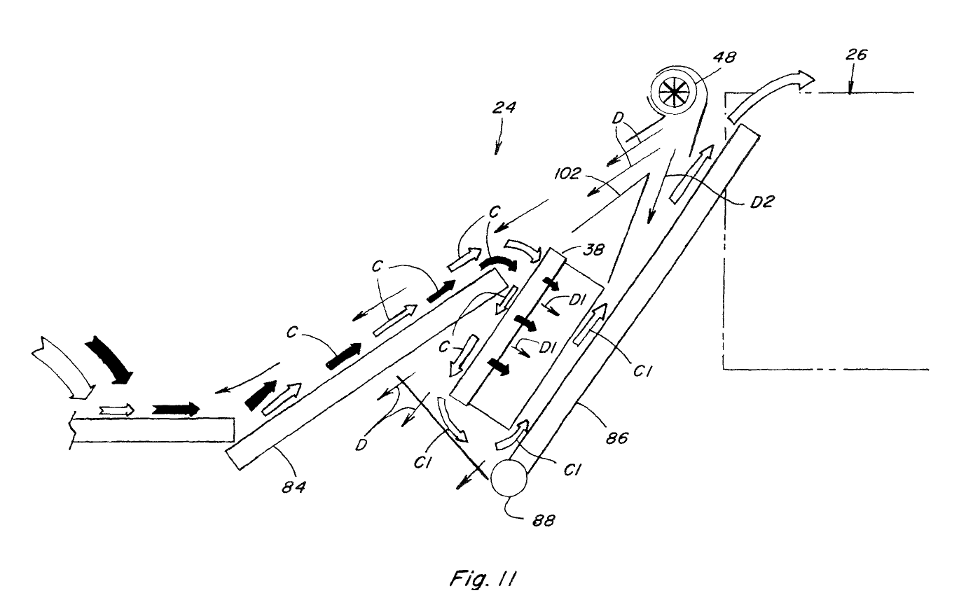

Referring also to FIGS. 10 and 11, as additional alternative constructions, system 24 can be configured with blower 48 at one or more alternative locations, such as below inclined apparatus 38 (FIG. 10), for directing flow of air D upwardly along apparatus 38 and optionally, a flow D2 upwardly along conveyor 86 using a flow divider or dividers 102 if necessary; and another location higher above inclined apparatus 38 and conveyor 86 (FIG. 11), for directing air flow D downwardly along inclined apparatus 38 and optionally flow D2 downwardly along third conveyor 86, again employing a flow divider or dividers 102 if required. Flows D2 can be used for removing or cleaning at least some of any remaining stover mixed with the cobs of flow C1, as it is conveyed along conveyor 86, and before discharge into collection device 26.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A conveyor system for removing attached husks from cobs after harvesting corn therefrom, comprising:
an inclined husk removing apparatus having a first end, an opposite second end lower than the first end, and an array of husking rolls extending therebetween defining an upwardly facing inclined surface configured and positioned for passage of the flow of the cobs including the attached husks thereover; and
apparatus for directing the flow of the cobs over the husking rolls in a variety of orientations in an agitated manner for bringing at least a substantial number of the husks attached to the cobs into contact with the husking rolls, each of the husking rolls bounding a gap in the husk removing apparatus smaller than the cobs and connecting with a region below the husk removing apparatus and being supported for rotation about an axis through the husking roll, each of the husking rolls being connected to a drive configured for drivingly rotating the husking roll about the axis therethrough in a direction toward the gap bounded thereby, respectively, and the husking rolls including husking elements thereon configured and operable as the rolls are rotated in contact with the attached husks, for grasping and detaching the husks from the cobs and driving the detached husks through the gaps into the region below the husk removing apparatus.

2. The conveyor system of claim 1, wherein the apparatus for directing the flow of the cobs over the husking rolls comprises at least one blower configured and operable for generating a flow of air over the husking rolls and downwardly into the gaps bounded thereby.

3. The conveyor system of claim 2, wherein the blower is configured and operable for directing the flow of air generally downwardly over the husking rolls.

4. The conveyor system of claim 2, wherein the blower is configured and operable for directing the flow of air generally upwardly over the husking rolls.

5. The conveyor system of claim 2, wherein the at least one blower is configured to generate the flow of air over the husking rolls in a manner to create an air pressure condition in the passage greater than a pressure condition in the region below the husk removing apparatus, to cause the flow of air through the gaps.

6. The conveyor system of claim 5, comprising at least one conveyor disposed and configured for conveying the flow of the cobs in an airborne stream into the flow of air, such that the flow of air will carry the cobs into proximity to the inclined husk removing apparatus for bringing the attached husks into contact with the husking rolls thereof.

7. The conveyor system of claim 6, wherein the conveyor is disposed at least partially above the inclined husk removing apparatus, in spaced relation thereto, defining a passage for the flow of the cobs in proximity to, above and along, the inclined husk removing apparatus.

8. The conveyor system of claim 1, comprising at least one conveyor configured and operable for receiving the cobs from the inclined husk removing apparatus and conveying the cobs into a cob collection device.

9. A conveyor system for receiving corn cobs with husks still attached thereto after harvesting of the corn from the cobs, and detaching the husks from the cobs, comprising:
a conveyor inclined at an angle of at least about 30 degrees and bounding a lower periphery of a passage for receiving a downward flow of the cobs including the husks attached thereto, the conveyor including apparatus configured and operable for mechanically grasping and detaching the husks from the cobs and pulling the detached husks through the conveyor; and
at least one blower configured and operable for urging the husks within the passage toward the apparatus.

10. The conveyor system of claim 9, wherein the conveyor system further comprises apparatus configured and operable for removing the husks from a region below the inclined conveyor.

11. The conveyor system of claim 10, wherein the apparatus configured and operable for removing the husks from the region below the inclined conveyor comprises apparatus for directing a flow of air from the blower through the region.

12. The conveyor system of claim 11, comprising at least one additional conveyor disposed and configured for receiving the cobs from the inclined conveyor and conveying the cobs into a cob collection device.

13. The conveyor system of claim 12, wherein the additional conveyor is disposed at least partially below the inclined conveyor.

14. The conveyor system of claim 13, comprising at least one additional conveyor disposed and configured for conveying the flow of the cobs in an airborne stream into the passage.

15. The conveyor system of claim 9, wherein the apparatus configured and operable for mechanically grasping and detaching the husks from the cobs and pulling the detached husks through the conveyor comprises an array of elongate husking rolls, each of the husking rolls bounding a gap in the inclined conveyor smaller than the cobs and connecting with a region below the inclined conveyor, a drive connected in driving relation to the husking rolls and operable for rotating the rolls toward the gaps, respectively, and the husking rolls including husking elements thereon configured such that when the husking rolls are rotated by the drive toward the gaps, the elements will grasp and detach the husks from the cobs and drive the detached husks through the gaps into the region below the inclined conveyor.

16. The conveyor system of claim 15, wherein the husking rolls extend generally horizontally across the passage.

17. The conveyor system of claim 15, wherein the husking rolls extend upwardly and downwardly along the passage.

18. The conveyor system of claim 15, wherein the at least one blower is configured to generate a flow of air over the husking rolls in a manner to create an air pressure condition in the passage greater than a pressure condition in the region below the inclined conveyor, to cause the flow of air through the gaps.

19. The conveyor system of claim 18, wherein the blower is configured and operable for directing the flow of air downwardly into the passage.

20. The conveyor system of claim 18, wherein the blower is configured and operable for directing the flow of air upwardly into the passage.

21. A device for towing behind a corn harvesting machine, for receiving, de-husking and collecting corn cobs after removal of the corn therefrom, comprising:
a trailer carrying a cob collection device including an upstanding wall structure bounding an interior chamber configured for receiving a quantity of cobs therein;
a conveyor system carried on the trailer and configured and operable for receiving a flow of the cobs from the harvesting machine, wherein some of the cobs will include the husks attached thereto, the conveyor system including a first conveyor portion configured for conveying the cobs and including apparatus for removing loose corn residue therefrom, an inclined husking conveyor portion including apparatus configured and operable for mechanically grasping and detaching the attached husks from the cobs and conveying the detached husks downwardly through the inclined conveyor portion, and including apparatus for disposing of the detached husks, and a conveyor portion configured and operable for conveying the cobs from the inclined conveyor portion into the interior chamber of the cob collection device.

22. The device of claim 21, wherein the inclined conveyor portion is oriented at an angle of at least about 30 degrees relative to horizontal.

23. The device of claim 21, wherein the apparatus configured and operable for mechanically grasping and detaching the attached husks from the cobs comprises an array of husking rolls defining an upwardly facing inclined surface configured and positioned for receiving the flow of the cobs and conveying the cobs downwardly, each of the husking rolls bounding a gap sufficiently large for passage of the husks therethrough but smaller than the cobs, each of the husking rolls being supported for rotation about an axis therethrough and connected to drive apparatus configured for drivingly rotating the husking rolls about the axes, respectively, the husking rolls including husking elements thereon configured such that when the husking rolls are rotated by the drive, the elements will positively grasp and detach the husks from the cobs and drive the detached husks through the gaps into a region below the inclined conveyor portion.

24. The device of claim 23, further comprising at least one blower configured and operable for blowing the husks from the region below the inclined conveyor portion.

25. The device of claim 23, wherein the husking rolls extend generally horizontally across the inclined conveyor portion.

26. The device of claim 23, wherein the husking rolls extend upwardly and downwardly along the inclined conveyor portion.

27. The device of claim 23, further comprising at least one blower configured to generate a flow of air over the husking rolls in a manner to create an air pressure condition in the passage greater than a pressure condition in the region below the inclined conveyor portion, to cause the flow of air through the gaps.
